(19) United States
(12) Patent Application Publication
(10) Pub. No.: US 2011/0175511 A1
(43) Pub. Date: Jul. 21, 2011

(54) LIGHT EMITTING DIODE AND LIGHT SOURCE MODULE HAVING SAME

(75) Inventor: Chih-Ming LAI, Chu-Nan (TW)

(73) Assignee: FOXSEMICON INTEGRATED TECHNOLOGY, INC., Chu-Nan (TW)

(21) Appl. No.: 12/766,917

(22) Filed: Apr. 25, 2010

(30) Foreign Application Priority Data
Jan. 19, 2010 (CN) 201010300440.0

(51) Int. Cl. H01J 61/52

(52) U.S. Cl. 313/46

(57) ABSTRACT

An exemplary light emitting diode includes a light emitting diode chip, a casting, two metallic electrodes, and a heat sink. The casting has a first surface and a second surface at two opposite sides thereof. In addition, the casting has a receiving space defined in the first surface for receiving the light emitting diode chip and a hole extending from the light emitting diode chip to the second surface. The two metallic electrodes each are coupled to the casting and extending to the first surface. The heat sink fills in the hole and thermally contacts the light emitting diode chip, and the heat sink is thermally and electrically insulated from the two metallic electrodes by the casting.

### TECHNICAL FIELD

The disclosure generally relates to light emitting diodes (LEDs), and particularly to an LED operating efficiently and a light source module using the LED.

### DESCRIPTION OF RELATED ART

In recent years, due to excellent light quality and high luminous efficiency, light emitting diodes (LEDs) have increasingly been used as a substitute for cold cathode fluorescent lamps (CCFLs) as a light source of an illumination device.

Referring to FIG. 10, a typical LED 100 includes two metallic electrodes 102, a housing 103, an LED chip 104, and an encapsulation layer 106. The housing 103 covers part of each metallic electrode 102. The LED chip 104 is mounted on one of the metallic electrodes 102 and electrically connects to the other metallic electrode 102 via a wire (not labeled). The encapsulation layer 106 covers the LED chip 104. The LED 100 is mounted on a circuit board 120 when in use. The circuit board 120 applies electric current to the LED chip 104. The LED chip 104 emits light and generates heat. The light passes through the encapsulation layer 106 to illuminate an ambient environment. The heat is transferred to the circuit board 108 through the metallic electrode 102 in which the LED chip 104 is mounted. However, the metallic electrode 102 is used to apply electric current to the LED chip 104, as well as transfer heat from the LED chip 104. In such case, thermal resistance of the metallic electrode 102 can be relatively high. The heat from the LED chip 104 may not dissipate quickly enough; thus, light intensity of the LED 100 may be attenuated gradually, shortening life thereof.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is cross-section of an LED, in accordance with a first embodiment.

FIG. 2 is cross-section of an LED, in accordance with a second embodiment.

FIG. 3 is cross-section of an LED, in accordance with a third embodiment.

FIG. 4 is cross-section of an LED, in accordance with a fourth embodiment.

FIG. 5 is cross-section of an LED, in accordance with a fifth embodiment.

FIG. 6 is cross-section of an LED, in accordance with a sixth embodiment.

FIG. 7 is cross-section of a light source module using an LED from FIG. 6.

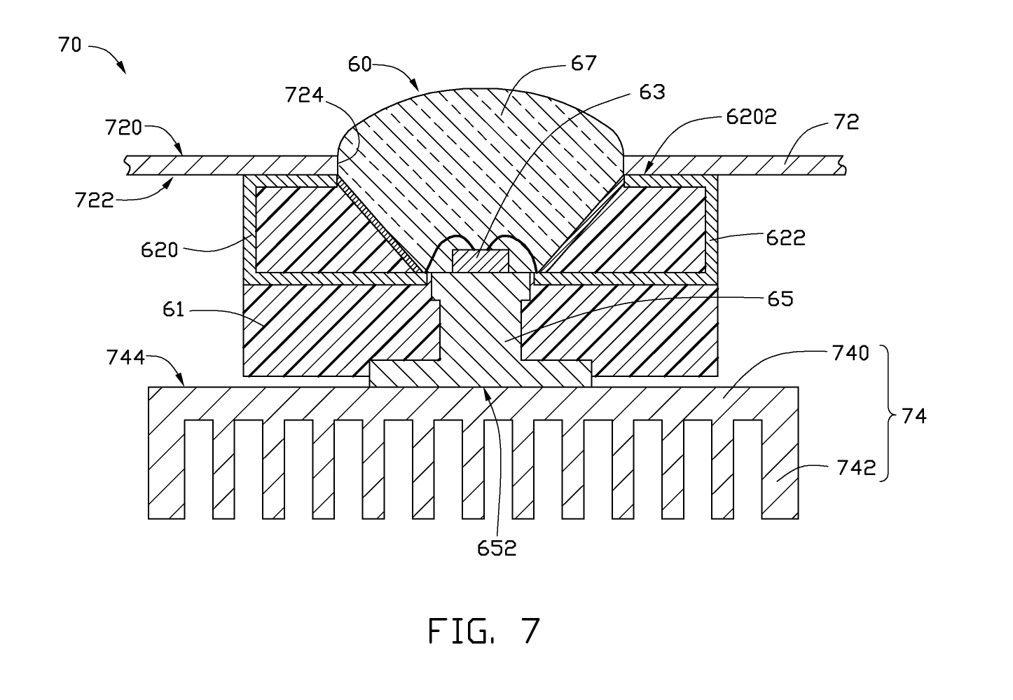

FIG. 8 is cross-section of a light source module using two LEDs from FIG. 5.

FIG. 9 is cross-section of a light source module using two LEDs from FIG. 3.

FIG. 10 is cross-section of a typical LED.

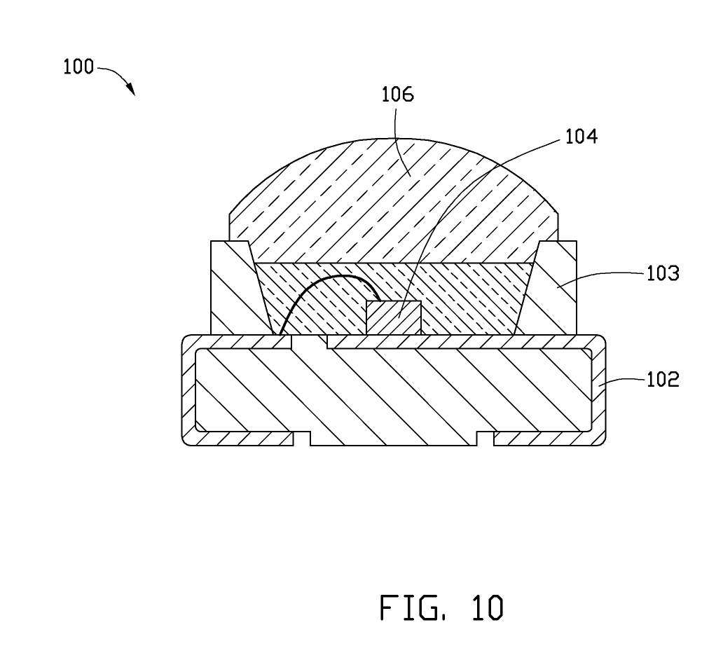

### DETAILED DESCRIPTION

Embodiments of the LEDs will now be described in detail below and with reference to the drawings.

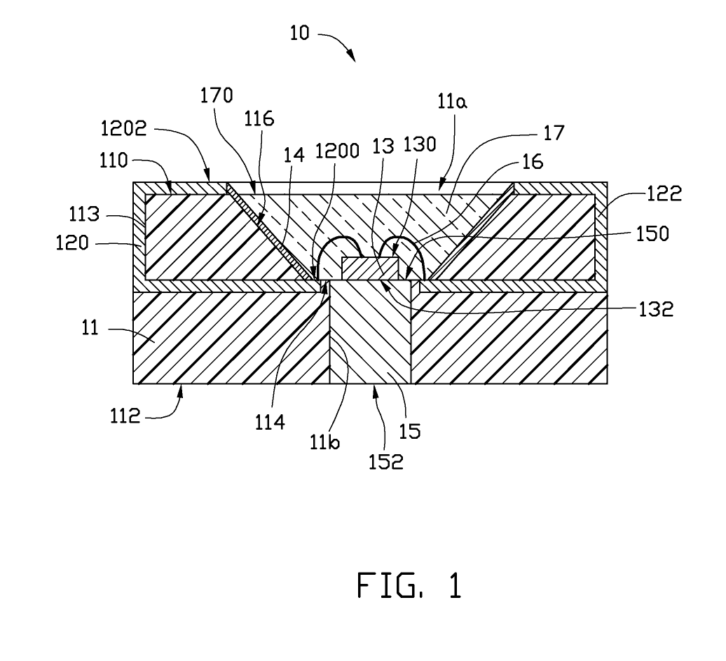

Referring to FIG. 1, an LED 10 in accordance with a first embodiment is shown. The LED 10 includes a casting 11, two metallic electrodes 120 and 122, an LED chip 13, a heat sink 15, and an encapsulation layer 17.

The casting 11 may have a general cuboid shape, a general cylindrical shape or a general disk shape, and includes a first surface 110 and a second surface 112, and a peripheral side surface 113. The first surface 110 and the second surface 112 are located at two opposite sides of the casting 11. The peripheral side surface 113 is located between and adjoins the first surface 110 and the second surface 112. A base material of the casting 11 has high heat resistance and good electrical insulation property. One example of the base material can be liquid crystal polymer (LCP) or thermoplastic resin, such as polybutylene terephthalate (PBT). Alternatively, titanium dioxide or aluminum oxide in the form of particles can be mixed in the base material of the casting 11; thus, the casting 11 may have the ability to sustain high temperature.

The casting 11 has a receiving space 11 a defined in the first surface 110 for receiving the LED chip 13. The casting 11 includes a bottom surface 114 and a lateral surface 116 surrounding the bottom surface 114 in the receiving space 11a. The receiving space 11a may have frusto-conical shape tapering from the first surface 110 to the bottom surface 114. The lateral surface 116 may have a reflective layer 14 coated thereon. The reflective layer 14 is configured to reflect light from the LED chip 13 to the outside of the receiving space 11a. The casting 11 further has a hole 11b defined in the bottom surface 114 to communicate with the receiving space 11a. The hole 11b can be generally rectangular. In this embodiment, the hole 11b has a cylindrical shape.

The heat sink 15 fills in the hole 11b and includes an upper surface 150 and a lower surface 152. In this embodiment, the heat sink 15 fully fills the hole 11b. The upper surface 150 is coplanar with the bottom surface 114 in the receiving space 11a, and the lower surface 152 is coplanar with the second surface 112 of the casting 11. The heat sink 15 may be made of metal material, such as copper, silver, or an alloy thereof, or another suitable metal or alloy.

The metallic electrodes 120 and 122 are used to electrically connect to the LED chip 13. Both of the metallic electrodes 120 and 122 may be further connected to an exterior power supply (not shown) mounted on a circuit board (not shown). Thereby, electric current can be applied to the LED chip 13. In this embodiment, the metallic electrode 120 serves as a positive electrode, and the metallic electrode 122 serves as a negative electrode.

The metallic electrodes 120 and 122 each are partially covered by the casting 11 and electrically insulated from the heat sink 15 by the casting 11. In particular, each of the metallic electrodes 120 and 122 is deformed. In this embodiment, each of the metallic electrodes 120 and 122 extends from the bottom surface 114 in the receiving space 11a to the peripheral side surface 113 all through the inside of the casting 11, and further extends from the peripheral side surface 113 to the first surface 110. The metallic electrodes 120 and 122 each have a mounting surface portion 1200 exposed in the receiving space 11a. The mounting surface portion 1200 is coplanar with the bottom surface 114 in the receiving space 11a. In addition, each of the metallic electrodes 120 and 122 has an end surface portion 1202 covering the first surface 110 and exposed to the outside of the LED 10. In alternative embodiments, each of the metallic electrodes 120, 122 may not necessarily extend to the peripheral side surface 113. Instead, each of the metallic electrodes 120 and 122 may extend from the bottom surface 114 to the first surface 110 through the lateral surface 116.

The LED chip 13 may be essentially made of phosphide such as AlₓIn_{y}Ga_{(1-x-y)}P(0≦x≦1, 0≦y≦1, x+y≦1) or arsenide, such as AlInGaAs, or another suitable material, for example nitrides such as InₓAl_{y}Ga_{(1-x-y)}N (0≦x≦1, 0≦y≦1, x+y≦1). The LED chip 13 may include a substrate (not labeled) made of intrinsic semiconductor or unintentionally doped semiconductor. A carrier concentration of the substrate is less than or equal to 5×10⁶cm⁻³, or preferably less than or equal to 2×10⁶cm⁻³. The substrate of the LED chip 13 with less carrier concentration may have lower conductivity; thus, electric current following through the casting may be avoided. Accordingly, electric current applied to the LED chip 13 can be efficiently used, and the LED chip 13 emits light efficiently. The substrate of the LED chip 13 can be made of spinel, SiC, Si, ZnO, GaN, GaAs, GaP, or AlN. Alternatively, the substrate of the LED chip 13 may be made of material with high thermal conductivity and good electrical insulation property, such as diamond.

The LED chip 13 includes a light emitting surface 130 and a mounting surface 132 at two opposite sides thereof. In this embodiment, the LED chip 13 is arranged on the upper surface 150 of the heat sink 15, and can be attached to heat sink 15 directly. In one typical embodiment, a eutectic process can be applied when the LED chip 13 is attached to heat sink 15. The eutectic process can be applied by adhering the material of the LED chip 13 with the material of the heat sink 15 within an ultrasonic field and high temperature environment. Such adhesion can be achieved by melting, bonding, or fusing. In alternative embodiments, the LED chip 13 may be attached to the heat sink 15 via an adhesive layer (not shown). The adhesive layer can be coated on either or both of the mounting surface 132 and the upper surface 150, before the LED chip 13 is attached to the heat sink 15. The adhesive layer may be made of metallic material selected from the group consisting of gold, tin, and silver; or the adhesive layer may be colloidal silver, or solder paste, or another suitable adhesive material.

The LED chip 13 is electrically connected to the metallic electrodes 120 and 122 through two wires 16. In particular, two distal ends (not labeled) of each wire 16 can be attached to the mounting surface portion 1200 and the light emitting surface 130 by wire bonding.

The encapsulation layer 17 fills in the receiving space 11 a to cover the LED chip 13, the reflective layer 14, and the two wires 16. In this embodiment, the encapsulation layer 17 includes an output surface 170 adjoining the reflective layer 14 and facing the light emitting surface 130 of the LED chip 13. The LED chip 13 emits light from the light emitting surface 130. The light transmits in the encapsulation layer 17 and passes all the way through the output surface 170 to an ambient environment. The encapsulation layer 17 is configured for optically adjusting (e.g., diverging or converging) a direction of the light emitted from the LED chip 13, thus adjusting an illuminating scope of the LED 10. In addition, the encapsulation layer 17 protects the LED chip 13 from contaminants. A base material (not shown) of the encapsulation layer 17 can be made of light-pervious material selected from the group consisting of resin, silicone, glass, epoxy, polyethylene terephthalate, polymethyl methacrylate, and polycarbonate. In this embodiment, the encapsulation layer 17 may further include at least one optical wavelength converting material, mixed essentially uniformly in the base material. The at least one optical wavelength converting material can be in the form of particles, and may include one kind of phosphor or different kinds of phosphors. The phosphor or phosphors for example, can be red phosphor, yellow phosphor, green phosphor, or phosphors having other colors. The phosphor or phosphors may be comprised of one of sulfides, aluminates, oxides, silicates and nitrides. For example, the phosphor or phosphors may be Ca₂Al₁₂O₁₉:Mn, (Ca, Sr, Ba)Al₂O₄:Eu, CdS, CdTe, Y₃A₁₅O₁₂Ce³⁺ (YAG), Tb₃Al₅O₁₂:Ce³⁺ (YAG), BaMgAl₁₀O₁₇:Eu²⁺ (Mn²⁺), Ca₂Si₅N₈:Eu²⁺, (Ca, Sr, Ba)S:Eu²⁺, (Mg, Ca, Sr, Ba)₂SiO₄:Eu²⁺, (Mg, Ca, Sr, Ba)₃Si₂O₇:Eu²⁺, Y₂O₂S:Eu³⁺, Ca₈Mg(SiO₄)₄Cl₂:Eu²⁺, (Sr, Ca, Ba)SiₓO_{y}N_{z}:Eu²⁺, (Ca, Mg, Y)SiwAlₓO_{y}N_{z}:Eu²⁺, or CdSe.

In operation, electric current is applied to the LED chip 13, whereby the LED chip 13 emits light to an ambient environment through the encapsulation layer 17. The heat sink 15 dissipates the heat generated by the LED chip 13 to the outside of the LED 10. In this manner, the LED chip 13 may operate continually within an acceptable temperature range to achieve stable optical performance, and the brightness and the luminous efficiency of the LED 10 are stably maintained.

One advantage of the LED 10 is that the metallic electrodes 120 and 122 are thermally and electrically insulated from the heat sink 15 by the casting 11. Heat generated from the LED chip 13 and electric current applied to the LED chip 13 cannot affect each other. Therefore, the LED 10 emits light efficiently as well as dissipates heat efficiently.

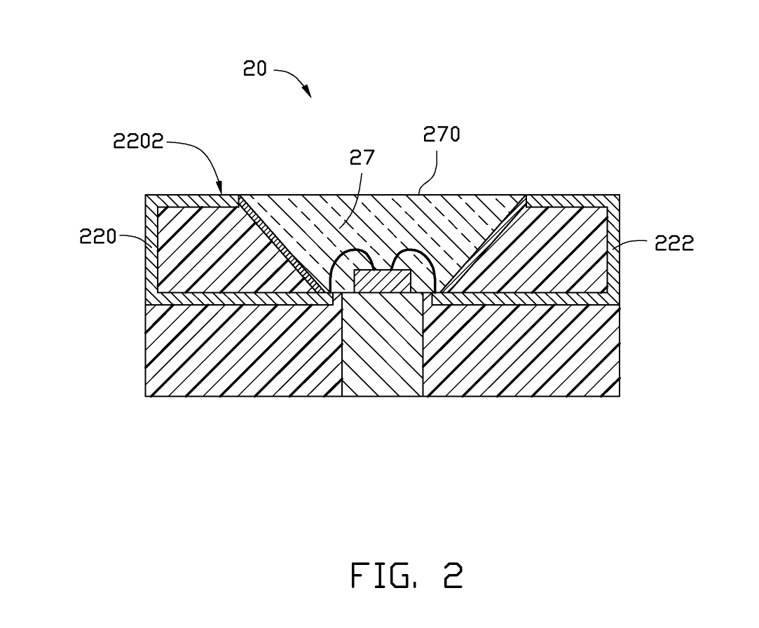

Referring to FIG. 2, an LED 20, in accordance with a second embodiment, is shown. The LED 20 is similar to the LED 10 in the first embodiment. However, an encapsulation layer 27 of the LED 20 has an output surface 270 coplanar with an end surface portion 2202 of each metallic electrode 220 and 222. The LED 20 in this embodiment can be equipped with another component, such as a light guide plate (not shown) by attaching the end surface portion 2202 to the light guide plate. In this manner, the encapsulation layer 27 intimately contacts the light guide plate. Light from the LED 20 is able to directly travel into the light guide plate through the output surface 270. As such, low optical loss is achieved.

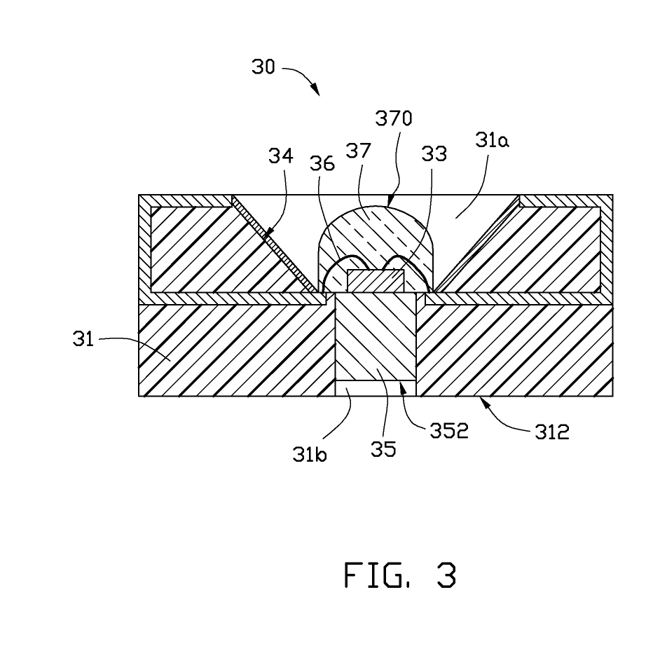

FIG. 3 shows an LED 30 according to a third embodiment. The LED 30 is similar to the LED 10 in the first embodiment, and includes a casting 31, an LED chip 33, a reflective layer 34, a heat sink 35, and an encapsulation layer 37. However, for the LED 30, the encapsulation layer 37 is not necessarily covering the reflective layer 34. Instead, in this embodiment, the encapsulation layer 37 covers the LED chip 23 and the two wires 36 only. In addition, the encapsulation layer 37 includes an output surface 370 in the form of an arc-shape. Furthermore, in this embodiment, the heat sink 35 is not necessarily fully filling a though hole 31b of the casting 31. Instead, the heat sink 35 is partially received in the though hole 31b, and a lower surface 352 of the heat sink 35 faces away from the second surface 312 of the casting 31. The lower surface 352 and the second surface 312 cooperatively form a step surface (not labeled).

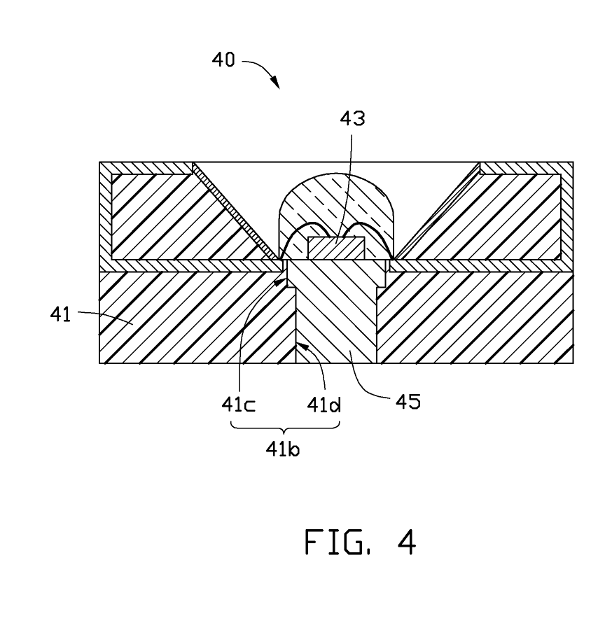

FIG. 4 shows an LED 40 according to a fourth embodiment. The LED 40 is similar to the LED 30 in the third embodiment, and includes a casting 41 with a hole 41b, an LED chip 43, and a heat sink 45. However, in this embodiment, the hole 41b of the casting 41 is a step hole. The hole 41b includes a first portion 41c adjacent to the LED chip 43 and a second portion 41d farther from the LED chip 43. Each of the first portion 41c and the second portion 41d has a cylindrical shape. The first portion 41c is a larger size than the second portion 41d. The heat sink 45 fully fills the though hole 41b. Accordingly, a portion of a heat sink 45 adjacent to the LED chip 43 has a larger size than the other portion of the heat sink 45 farther from the LED chip 43. The heat sink 45 can be securely received in the hole 41b.

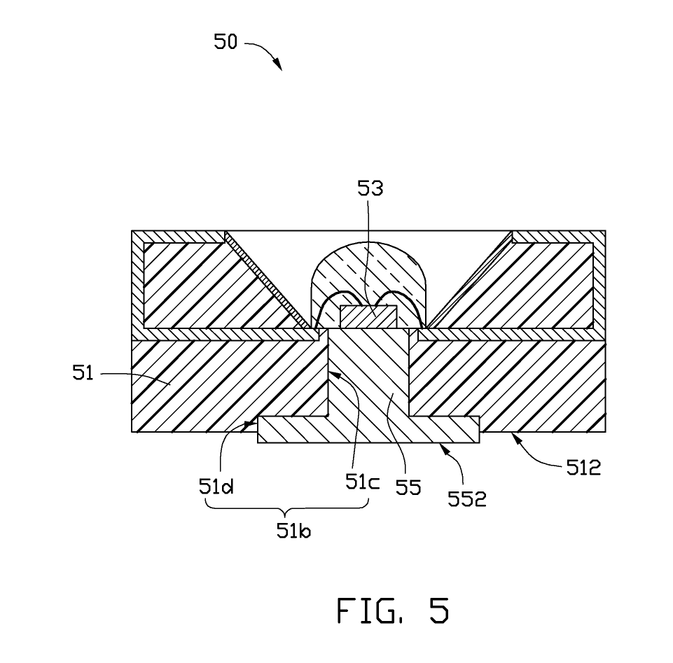

FIG. 5 shows an LED 50 according to a fifth embodiment. The LED 50 is similar to the LED 40 in the fourth embodiment, and includes a casting 51 with a hole 51b, an LED chip 53, and a heat sink 55. The hole 51b includes a first portion 51c adjacent to the LED chip 53 and a second portion 51d farther from the LED chip 53. However, in this embodiment, the first portion 51c has a smaller size than the second portion 51d. Accordingly, a portion of a heat sink 55 adjacent to the LED chip 53 has a smaller size than the other portion of the heat sink 55 farther from the LED chip 53. In addition, the heat sink 55 further protrudes from a second surface 512 of the casting 51. A lower surface 552 and the second surface 512 cooperatively form a step surface (not labeled).

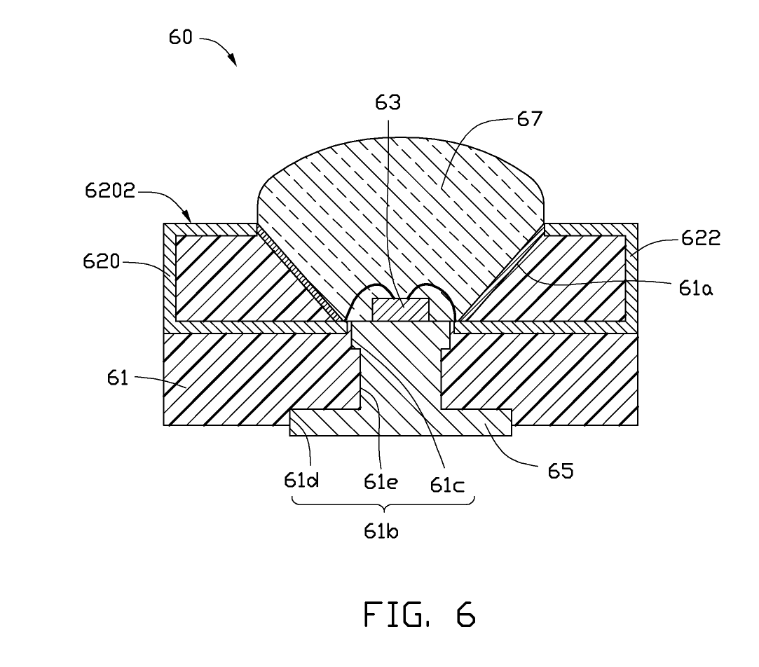

FIG. 6 shows an LED 60 according to a fifth embodiment. The LED 60 is similar to the LED 50 in the fifth embodiment, and includes a casting 61 with a receiving space 61a and a hole 61b, two metallic electrodes 620 and 622, an LED chip 63, a heat sink 65, and an encapsulation layer 67. However, in this embodiment, the hole 61b of the casting 61 includes a first portion 61c adjacent to the LED chip 63, a second portion 61d farther from the LED chip 63, and a third portion 61e. The third portion 61e is located between and adjoins the first portion 61c and the second portion 61d. The third portion 61e has a size smaller than either of the first and the second portions 61c, 61d. The second portion 61d has a size larger than the first portion 61c. In addition, the encapsulation layer 67 fully fills the receiving space 61a, and the encapsulation layer 67 protrudes from an end surface portion 6202 of each metallic electrode 620 and 622.

The disclosure further relates to a light source module using at least one of the LEDs 10˜60 from the first to the sixth embodiments. For example, a light source module 50 in accordance with a seventh embodiment using the LED 60 from the sixth embodiment as shown in FIG. 6, is described below.

The light source module 70 includes a circuit board 72, an LED 60 mounted on the circuit board 72, and a heat dissipation device 74 connected to the LED 60. The LED 60 in the sixth embodiment is used as a light source for illumination.

The heat dissipation device 74 is configured to dissipate heat from the LED 60. In this embodiment, the heat dissipation device 74 includes a base 740 connecting the heat sink 65 of the LED 60, and a number of fins 742 extending from the base 740 and facing away from the LED 60. The base 740 includes a base surface 744 contacting the heat sink 65 of the LED 60. In particular, the LED 60 can be attached to the base 740 by an adhesive layer (not shown). The adhesive layer can be coated on either or both of the lower surface 652 and the base surface 744, before the LED 60 is attached to the base 740. In operation, heat from the LED 60 can be transferred to the fins 742 through the base 740. The fins 742 increase the surface area contacting the air. Thus, if there is a need, more heat can be dissipated to the air.

The circuit board 72 includes a third surface 720 and an opposite fourth surface 722 at two opposite sides thereof. In this embodiment, the circuit board 72 has a hole 724 defined in the third surface 720 for allowing the encapsulation layer 67 of the LED 60 to extend therethrough. In mounting the LED 60 to the circuit board 72, the metallic electrodes 620 and 622 are attached to the circuit board 72 by an adhesive layer (not shown). The adhesive layer can be coated on either or both of the end surface portions 6202 and the fourth surface 722, before the LED 60 is attached to the circuit board 72. The adhesive layer may be made of metallic material selected from the group consisting of gold, tin, and silver; or the adhesive layer may be colloidal silver, or solder paste, or another suitable adhesive material.

The circuit board 72 generally includes a power supply (not shown) to apply electric current to the LED chip 63 through the metallic electrodes 620 and 622. In this embodiment, the circuit board 72 is thermally and electrically insulated from the heat sink 65 and the heat dissipation device 74. Heat generated from the LED 60 and electric current applied to the LED 60 may not affect each other. Therefore, light source module 70 emits light efficiently as well as dissipates heat efficiently.

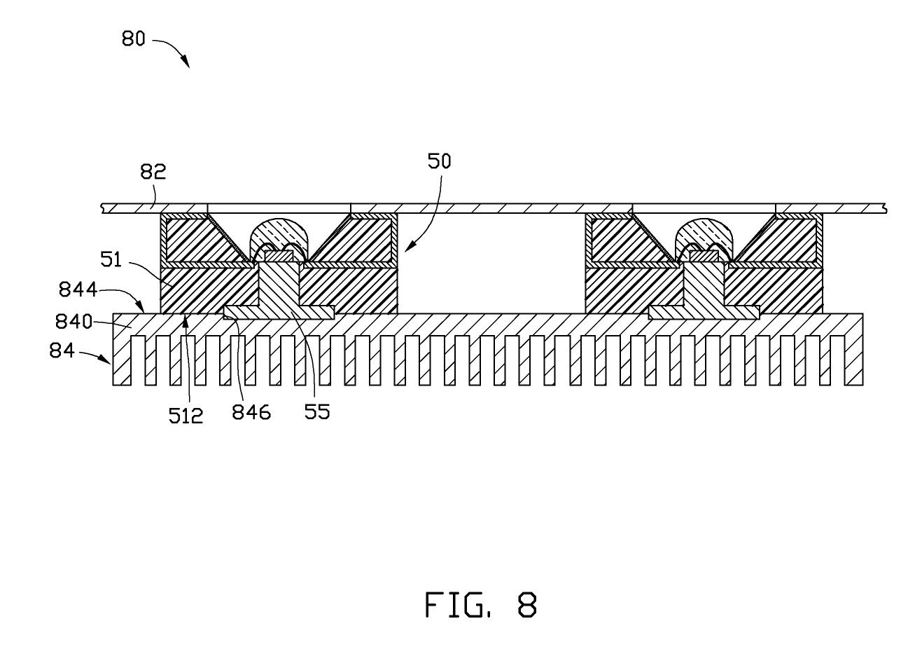

FIG. 8 shows a light source module 80 according to an eighth embodiment. The light source module 80 is similar to the source module 70 in the seventh embodiment in principle, and includes a circuit board 82, a heat dissipation device 84 with a base 840. However, in this embodiment, the light source module 80 includes more than one, for example two LEDs 50 from the fifth embodiment for illumination. In addition, the base 840 further has two recesses 846 defined in a base surface 844 thereof. The two recesses 846 are configured to fittingly receive the two respective heat sinks 55 protruding from the second surface 512 of the casting 51. Therefore, the two heat sinks 55 has sufficient surface area contacting the base 840, and heat from the LEDs 50 can be transferred to the heat dissipation device 84 and then dissipated to an ambient environment more efficiently. In this embodiment, the second surface 512 of the casting 51 intimately contacts the base surface 844.

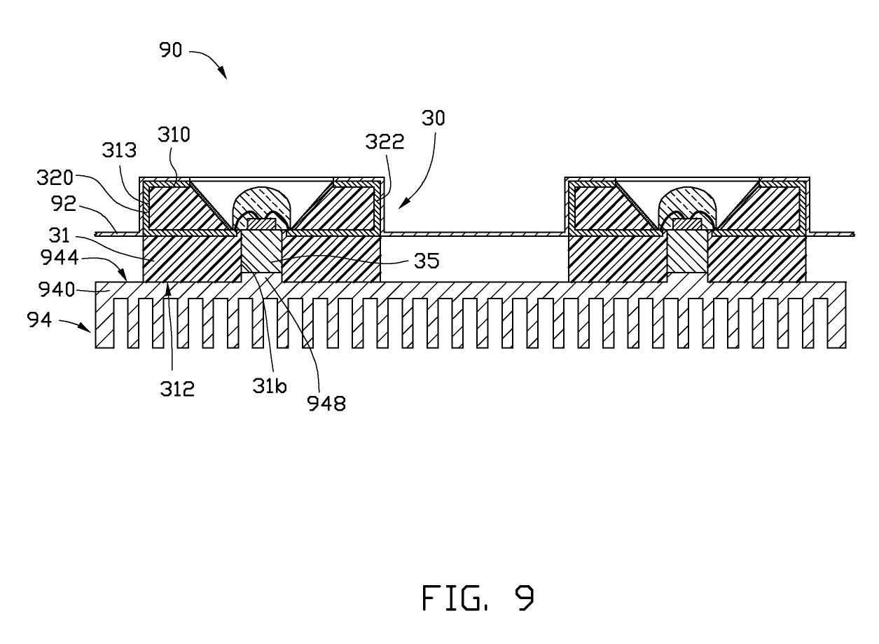

FIG. 9 shows a light source module 90 according to a ninth embodiment. The light source module 90 is similar to the source module 70 in the eighth embodiment in principle, and includes a circuit board 92, a heat dissipation device 94 with a base 940. However, in this embodiment, the light source module 90 includes two LEDs 30 of the third embodiment for illumination. The circuit board 92 is a flexible printed circuit board (FPCB). A base material of the circuit board 92 can be polyester (PET), polyimide (PI), polyethylene naphthalate (PEN), epoxy, or fiberglass, or another suitable material. In use, the circuit board 92 can be deformed. Each of the LEDs 30 can be mounted on the circuit board 92 by attaching a portion of each metallic electrodes 320, 322 extending on the first surface 310 and the peripheral side surface 313 to the circuit board 92. In addition, the base 940 further has two protruding portions 948 protruding from the base surface 944 thereof. The two protruding portions 948 are configured to be fittingly engaged in the two respective holes 31b, thus thermally contacting the two heat sinks 35 received in the holes 31b. Therefore, the two heat sinks 35 has sufficient surface area contacting the base 940, and heat from the LEDs 30 can be transferred to the heat dissipation device 94 and then dissipated to an ambient environment more efficiently. In this embodiment, the second surface 312 of the casting 31 intimately contacts the base surface 944 of the base 94.

It is believed that the embodiments and their advantages will be understood from the foregoing description, and it will be apparent that various changes may be made thereto without departing from the spirit and scope of the disclosure or sacrificing all of its material advantages, the examples hereinbefore described merely being preferred or embodiments of the disclosure.

What is claimed is:

1. A light emitting diode comprising:
a light emitting diode chip;
a casting having a first surface and a second surface at two opposite sides thereof, and the casting having a receiving space defined in the first surface for receiving the light emitting diode chip and a hole extending from the light emitting diode chip to the second surface;
two metallic electrodes each coupled to the casting and extending to the first surface, the two electrodes electrically connecting with the light emitting diode chip; and
a heat sink filling in the hole and thermally contacting the light emitting diode chip, and the heat sink thermally and electrically insulated from the two metallic electrodes by the casting.

2. The light emitting diode of claim 1, wherein the heat sink is made of metallic material selected from the group consisting of aluminum, copper, and aluminum-copper alloy.

3. The light emitting diode of claim 1, wherein a base material of the casting is selected from the group consisting of liquid crystal polymer and thermoplastic resin.

4. The light emitting diode of claim 3, wherein at least one of titanium dioxide and aluminum oxide in the form of particles is mixed in the base material of the casting.

5. The light emitting diode of claim 1, wherein the hole has a cylindrical shape

6. The light emitting diode of claim 1, wherein the hole is a step hole, and the heat sink is fittingly received in the hole.

7. The light emitting diode of claim 1, wherein the heat sink is partially received in the hole, and the heat sink has a surface facing away from the second surface of the casting, the surface of the heat sink and the second surface of the casting cooperatively form a step surface.

8. The light emitting diode of claim 1, wherein the heat sink protruding from the second surface of the casting.

9. The light emitting diode of claim 1, further comprising two wires, the two wires electrically connecting the light emitting diode chip to the respective metallic electrodes.

10. The light emitting diode of claim 1, wherein the casting comprises a bottom surface and a lateral surface in the receiving space, and the lateral surface surrounds the bottom surface and has a reflective layer formed thereon, the hole is defined in the bottom surface.

11. The light emitting diode of claim 10, wherein each of the metallic electrodes extends from the bottom surface all the way through the inside of the casting to a peripheral side of the casting between the first surface and the second surface, and further extends from the peripheral side of the casting to the first surface.

12. A light source module comprising:
a light emitting diode, comprising:
a light emitting diode chip,
a casting having a first surface and a second surface at two opposite sides thereof, and the casting having a receiving space defined in the first surface for receiving the light emitting diode chip and a hole extending from the light emitting diode chip to the second surface,
two metallic electrodes each coupled to the casting and extending to the first surface, the two electrodes electrically connecting with the light emitting diode chip, and
a heat sink filling in the hole and thermally contacting the light emitting diode chip, and the heat sink thermally and electrically insulated from the two metallic electrodes by the casting;
a circuit board coupled to the two metallic electrodes, and the circuit board having at least one through hole defined therein for allowing light of the light emitting diode passing therethrough; and
a heat dissipation device coupled to an opposite side of the heat sink to the circuit board.

13. The light source module of claim 12, wherein the heat dissipation device comprising a base contacting the heat sink and a plurality of fins extending from the base.

14. The light source module of claim 13, wherein the heat sink protruding from the second surface of the casting.

15. The light source module of claim 13, wherein the base has a recess defined therein to fittingly engage the heat sink protruding from the second surface of the casting.

16. The light source module of claim 13, wherein the heat sink is partially received in the hole, and the heat sink has a surface facing away from the second surface of the casting, the surface of the heat sink and the second surface of the casting cooperatively form a step surface.

17. The light source module of claim 16, wherein the base comprises a protruding portion protruding from the base, and the protruding portion is configured to be fittingly engaged in the hole.

18. The light source module of claim 12, wherein each of the metallic electrodes extends from the recess all the way through the inside of the casting to a peripheral side of the casting between the first surface and the second surface, and further extends from the peripheral side of the casting to the first surface.

19. The light source module of claim 18, wherein the circuit board comprises a flexible printed circuit board.

20. The light source module of claim 19, wherein the light emitting diode is coupled to the circuit board by attaching a portion of each metallic electrode extending on the first surface and the peripheral side to the circuit board.
